(19) United States
(12) Patent Application Publication
(10) Pub. No.: US 2026/0202137 A1
(43) Pub. Date: Jul. 16, 2026

(54) HEAT EXCHANGER AND VEHICLE AIR CONDITIONING DEVICE

(71) Applicant: SANDEN CORPORATION, Isesaki-shi, Gunma (JP)

(72) Inventor: Akira KANEKO, Isesaki-shi, Gunma (JP)

(73) Assignee: SANDEN CORPORATION, Isesaki-shi, Gunma (JP)

(21) Appl. No.: 19/136,223

(22) PCT Filed: Dec. 25, 2023
(86) PCT No.: PCT/JP2023/046391

§ 371 Date: Jun. 5, 2025

(30) Foreign Application Priority Data
Jan. 20, 2023 (JP) 2023-007565

(51) Int. Cl. F28D 9/00; B60H 1/00

(52) U.S. Cl. CPC F28D 9/0093; B60H 1/00321; F28D 9/005

(57) ABSTRACT

A heat exchanger includes a plurality of heat exchange cores through which a first heat medium flows, and a case which is divided into a plurality of chambers by a partition portion, the heat exchange cores are each accommodated in the chambers adjacent to each other through the partition portion, each of the chambers is configured such that a second heat medium flows therethrough and heat is exchanged between the second heat medium and the first heat medium, each of the chambers has an inlet and an outlet for the second heat medium, and is configured to cause the second heat medium circulates in the each of the chambers to exchange heat between the second heat medium and the first heat medium, and a channel for the second heat medium on a downstream side in each of the chambers is provided at a position farther from the partition portion.

### CROSS-REFERENCE TO RELATED APPLICATIONS

This application is a U.S. National Stage Patent Application under 37 U.S.C. § 371 of International Patent Application No. PCT/JP2023/046391, filed on Dec. 25, 2023, which claims the benefit of Japanese Patent Application No. JP 2023-007565, filed on Jan. 20, 2023, the disclosures of each of which are incorporated herein by reference in their entirety.

### TECHNICAL FIELD

The present invention relates to a heat exchanger and a vehicle air conditioning device.

### BACKGROUND ART

Conventionally, there has been known a heat exchanger including an internal member through which refrigerant flows, and a case which is a container accommodating the internal member and through which cooling water flows in a space around the internal member (see Patent Literature 1). The heat exchanger described in Patent Literature 1 is mounted on a vehicle, and is configured as a heat exchanger for exchanging heat between refrigerant circulating in the vehicle and cooling water, and one internal member is accommodated in one rectangular parallelepiped case.

In addition, there has been known a configuration in which in a heat exchanger, a condensing unit and an evaporating unit are assembled by a header tank (see, for example, Patent Literature 2).

### CITATION LIST

### Patent Literature

Patent Literature 1: JP-A-2020-85340

Patent Literature 2: JP-A-2020-46101

### SUMMARY OF INVENTION

### Problems to be Solved by Invention

However, for example, in a vehicle air conditioning device or the like, there are a plurality of locations where a first heat medium (for example, refrigerant) and a second heat medium (for example, cooling water or the like) exchange heat. For this reason, when the heat exchangers as described in Patent Literature 1 are disposed at a plurality of necessary locations, problems such as an increase in cost and an increase in space in association with an increase in the number of components (in particular, case) arise.

Further, in a case where space saving of the vehicle air conditioning device is considered, for example, a method of disposing the condensing unit and the evaporating unit forming the heat exchanger close to each other or integrating these units with each other as in the technique described in Patent Literature 2 is also considered. However, in this case, since there is a great temperature difference between the heat media flowing therethrough, other components (for example, exterior, case, and the like) may be adversely affected. In particular, in a case where the exterior (case) of the heat exchanger is made of a resin material or the like, there is a problem that thermal distortion due to the temperature difference in the heat medium occurs and the case is damaged.

For these reasons, it is an object of the present invention to provide a heat exchanger configured such that highly-efficient heat exchange can be made, a cost can be reduced and a space can be saved in association with reduction in the number of components, and damage to a device exterior (case) can be prevented, and a vehicle air conditioning device including the heat exchanger.

### Solution to Problems

The present invention relates to a heat exchanger including a plurality of heat exchange cores through which a first heat medium flows, and a case of which the inside is divided into a plurality of chambers by a partition portion. The heat exchange cores are each accommodated in the chambers adjacent to each other through the partition portion, each of the chambers is configured such that a second heat medium flows therethrough and heat is exchanged between the second heat medium and the first heat medium, each of the chambers has an inlet and an outlet for the second heat medium, and is configured to cause the second heat medium to circulate in the each of the chambers to exchange heat between the second heat medium and the first heat medium, and a channel for the second heat medium on a downstream side in each of the chambers is provided at a position farther from the partition portion than a channel for the second heat medium on an upstream side.

The present invention also relates to a vehicle air conditioning device including the heat exchanger above.

### Effects of Invention

According to the present invention, the heat exchanger configured such that the highly-efficient heat exchange can be made, the cost can be reduced and the space can be saved in association with the reduction in the number of components, and the damage to the device exterior (case) can be prevented, and the vehicle air conditioning device including the heat exchanger can be provided.

### BRIEF DESCRIPTION OF DRAWINGS

FIG. 1 is a schematic view illustrating a vehicle air conditioning device according to an embodiment of the present invention.

FIG. 2 is a plan view schematically illustrating a heat exchanger according to the present embodiment.

FIG. 3 is a plan view schematically illustrating the heat exchanger according to the present embodiment.

FIG. 4 is a perspective view of the heat exchanger according to the present embodiment.

FIG. 5 is a perspective view of a heat exchange core according to the present embodiment.

FIG. 6 is a plan view schematically illustrating a modification of the heat exchanger according to the present embodiment.

### DESCRIPTION OF EMBODIMENTS

Hereinafter, embodiments of the present invention will be described in detail with reference to the drawings. In the following description, the same reference signs denote portions of the same functions, and redundant descriptions in the drawings are appropriately omitted. Further, in each figure, part of the configuration is appropriately omitted, and the drawing is simplified. In each figure, the size, shape, thickness, and the like of a member are appropriately exaggerated.

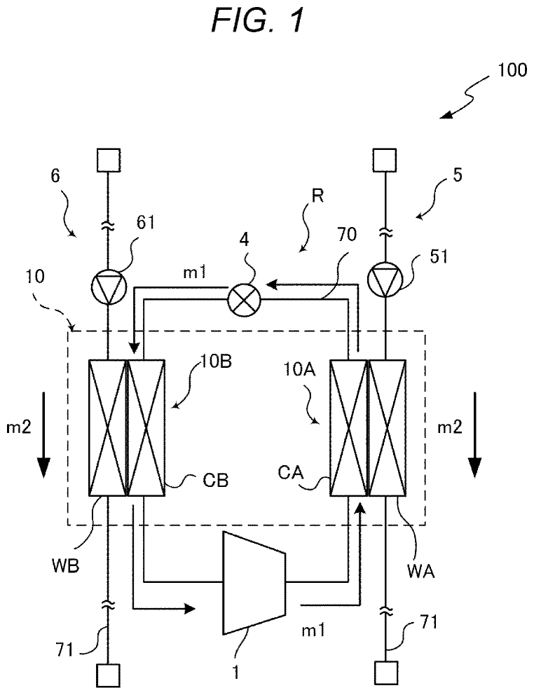

FIG. 1 is a schematic diagram illustrating an example of a main configuration of a vehicle air conditioning device 100 including a heat exchanger 10 according to an embodiment of the present invention. The heat exchanger 10 of the present invention can be applied to various devices that exchange heat between a first heat medium m1 and the second heat medium m2, and as an example, can be used in the vehicle air conditioning device 100. The first heat medium m1 is, for example, refrigerant (for example, fluorocarbon refrigerant such as R134a or R1234yf, natural refrigerant such as CO₂ or R290, or the like.), and the second heat medium m2 is a heat medium (for example, cooling water (LCC or water), antifreeze liquid, cooling oil, or the like) different from the first heat medium m1. Note that in the present embodiment, the refrigerant refers to a circulation medium in a refrigerant circuit R, which is accompanied by a state change in a heat pump (compression/condensation/expansion/evaporation). On the other hand, the second heat medium m2 is a circulation medium in a heat medium circuit including, for example, an internal combustion engine, a radiator, and the like, and refers to a medium that absorbs heat and dissipates heat with no state change as in the refrigerant. In the following description, a configuration referred to as the “refrigerant” corresponds to the first heat medium m1, and a configuration simply referred to as the “heat medium” corresponds to the second heat medium m2.

The vehicle air conditioning device 100 of the present embodiment may be mounted on a vehicle powered only by an internal combustion engine, but is suitably used for vehicles such as a hybrid electric vehicle (HEV) in which it is difficult to secure a sufficient amount of heat only by the waste heat of an internal combustion engine as compared with a vehicle powered only by an internal combustion engine, and an electric vehicle (EV) in which heating is unfeasible by the waste heat of an internal combustion engine. The vehicle such as an HEV or an EV is mounted with a battery (e.g., lithium battery), and is driven and travels by supplying power charged in the battery from an external power source to a motor unit including a traveling motor. The vehicle air conditioning device 100 is also driven with power supplied from the battery.

### <Overall Configuration>

As illustrated in FIG. 1, the vehicle air conditioning device 100 according to the present embodiment includes, for example, the refrigerant circuit R through which the refrigerant (first heat medium) m1 indicated by small arrows circulates, a first heat medium circuit 5 through which the heat medium (second heat medium) m2 indicated by large arrows circulates, and a second heat medium circuit 6 through which the heat medium (second heat medium) m2 circulates, and performs air conditioning of a vehicle interior by performing a heat pump operation using the refrigerant circuit R.

The first heat medium circuit 5 is, for example, a high-temperature side heat medium circuit through which the heat medium m2 circulates, which exchanges heat with the high-temperature refrigerant m1 flowing through the refrigerant circuit R. The second heat medium circuit 6 is, for example, a low-temperature side heat medium circuit through which the heat medium m2 circulates, which exchanges heat with the low-temperature refrigerant m1 flowing through the refrigerant circuit R. In the present embodiment, for the sake of convenience of description, the first heat medium circuit 5 is referred to as a high-temperature side heat medium circuit 5, and the second heat medium circuit 6 is referred to as a low-temperature side heat medium circuit 6.

As an example, the high-temperature side heat medium circuit 5 and the low-temperature side heat medium circuit 6 are connected through a pipe, and the same type of heat medium m2 flows therethrough. However, the present invention is not limited thereto, and independent circuits in which the high-temperature side heat medium circuit 5 and the low-temperature side heat medium circuit 6 are not connected through a pipe may be adopted. In this case, different types of heat media m2 may flow through the respective heat medium circuits.

### <Refrigerant Circuit>

The refrigerant circuit R includes a compressor 1, the heat exchanger 10, an expansion mechanism 4, and the like connected through a pipe (refrigerant pipe) 70. The compressor 1 sucks and compresses the refrigerant m1 from the upstream side in the refrigerant circuit R, and discharges the refrigerant m1 as high-temperature high-pressure gas toward the downstream side. The type of compressor 1 is not particularly limited, but for example, a piston type or scroll type electric compressor is adopted. Although not illustrated in the figure, an accumulator that separates liquid from the refrigerant m1 is provided on the upstream side of the compressor 1 in the refrigerant circuit R. The refrigerant circuit R causes the refrigerant m1 changed into the high-temperature high-pressure gas by the compressor 1 to pass through a first heat exchanger 10A and dissipate heat, thereby cooling the refrigerant m1. The refrigerant m1 having passed through the first heat exchanger 10A is decompressed by the expansion mechanism 4, and passes through a second heat exchanger 10B to absorb heat. Then, the low-pressure refrigerant m1 is compressed again by the compressor 1. This circulation is repeated.

### <Heat Exchanger>

The heat exchanger 10 of the present embodiment includes the first heat exchanger 10A and the second heat exchanger 10B. The first heat exchanger 10A exchanges heat, for example, between the heat medium m2 flowing through the high-temperature side heat medium circuit 5 and the refrigerant m1 flowing through the refrigerant circuit R. The second heat exchanger 10B exchanges heat, for example, between the heat medium m2 flowing through the low-temperature side heat medium circuit 6 and the refrigerant m1 flowing through the refrigerant circuit R.

### <First Heat Exchanger>

The first heat exchanger 10A is a refrigerant-heat medium heat exchanger having a refrigerant channel CA and a heat medium channel WA. The refrigerant channel CA is connected to the refrigerant circuit R, and the heat medium channel WA is connected to the high-temperature side heat medium circuit 5. In this example, the refrigerant channel CA of the first heat exchanger 10A forms part of the refrigerant circuit R, and functions as a radiator (heater, condenser) for the refrigerant m1 in the refrigerant circuit R. The heat medium channel WA of the first heat exchanger 10A forms part of the high-temperature side heat medium circuit 5, and functions as a heat absorber for the heat medium m2 in the high-temperature side heat medium circuit 5.

### <Second Heat Exchanger>

The second heat exchanger 10B is a refrigerant-heat medium heat exchanger having a refrigerant channel CB and a heat medium channel WB. The refrigerant channel CB is connected to the refrigerant circuit R, and the heat medium channel WB is connected to the low-temperature side heat medium circuit 6. In this example, the refrigerant channel CB of the second heat exchanger 10B forms part of the refrigerant circuit R, and functions as a heat absorber (cooler, evaporator) for the refrigerant m1 in the refrigerant circuit R. The heat medium channel WB of the second heat exchanger 10B forms part of the low-temperature side heat medium circuit 6, and functions as a radiator for the heat medium m2 in the low-temperature side heat medium circuit 6.

### <Expansion Mechanism>

The expansion mechanism 4 includes an expansion valve, a capillary tube, and the like, and decompresses and expands the high-pressure refrigerant m1, which has passed through the first heat exchanger 10A, into the low-pressure refrigerant m1.

### <First Heat Medium Circuit>

The first heat medium circuit (high-temperature side heat medium circuit) 5 is, for example, a circuit through which the heat medium m2 capable of exchanging heat with the refrigerant m1 of the refrigerant circuit R circulates, and for example, a circulation pump 51, the first heat exchanger 10A, and the like are connected through a pipe (heat medium pipe) 71. In the first heat medium circuit 5, for example, the heat medium m2 circulates via an indoor heat exchanger (not illustrated) (for example, a radiator of a heating ventilation and air-conditioning (HVAC) unit or the like).

### <Second Heat Medium Circuit>

The second heat medium circuit (low-temperature side heat medium circuit) 6 is, for example, a circuit through which the heat medium m2 capable of exchanging heat with the refrigerant m1 of the refrigerant circuit R circulates, and for example, a circulation pump 61, the second heat exchanger 10B, and the like are connected through a pipe (heat medium pipe 71). In the second heat medium circuit 6, for example, the heat medium m2 circulates via a heat exchange unit provided in temperature control equipment (not illustrated) (for example, battery, motor, or the like).

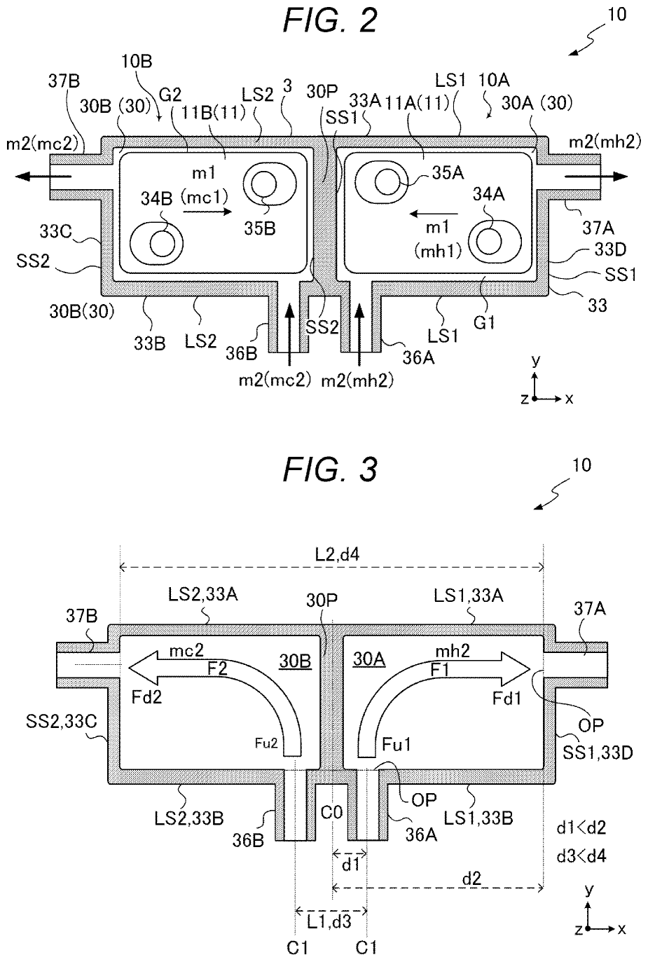

The heat exchanger 10 of the present embodiment will be described with reference to FIGS. 2 and 3. FIGS. 2 and 3 are schematic plan views illustrating a schematic configuration of the heat exchanger 10 according to the present embodiment. FIG. 3 is a view schematically illustrating the channel (indicated by outlined arrows) of the second heat medium m2 in each of a first chamber 30A and a second chamber 30B in the configuration illustrated in FIG. 2, and a first heat exchange core 11A and a second heat exchange core 11B are not illustrated.

In the description of the present embodiment, the description of upper and lower sides and the like is used, but such description of the upper and lower sides and the like is used for the sake of convenience to show the relative relationship of components in the drawing. That is, if the heat exchanger 10 is installed upside down from the illustrated state, the upper side described in the present embodiment is the lower side at the time of installation. Moreover, when the heat exchanger 10 is installed on its side and used, the upper-lower direction is changed to the lateral direction, and when the heat exchanger 10 is installed obliquely and used, the upper-lower direction is changed to the oblique upper-lower direction.

The first heat medium (refrigerant) m1 and the second heat medium (heat medium such as cooling water) m2 flow through the heat exchanger 10. In the present embodiment, for the sake of convenience of description, an x direction in the drawing, in which the refrigerant m1 circulates, is referred to as a circulation direction x, a y direction in the drawing, which is perpendicular to the circulation direction x, is referred to as a width direction y, and a z direction perpendicular to the circulation direction x and the width direction y is referred to as a lamination direction z. The refrigerant m1 may change in the circulation direction, such as turning back inside the heat exchanger 10, but a direction from an inflow side to an outflow side as a whole is defined as the circulation direction x. Note that in the present application, a ±direction and a −direction are not distinguished in the x, y, and z directions.

Referring to FIG. 2, the heat exchanger 10 of the present embodiment is configured as one device in which the first heat exchanger 10A and the second heat exchanger 10B illustrated separately on the circuit in FIG. 1 are integrated. The heat exchanger 10 includes a plurality of heat exchange cores 11 (here, first heat exchange core 11A and second heat exchange core 11B) and one case 3. Although described in detail later, the first heat exchange core 11A has an inlet 34A and an outlet 35A for the refrigerant m1, and has a refrigerant channel (refrigerant channel CA in FIG. 1) formed therein. The configuration and size of the second heat exchange core 11B are similar to those of the first heat exchange core 11A, and the second heat exchange core 11B has an inlet 34B and an outlet 35B for the refrigerant m1, and has a refrigerant channel (refrigerant channel CB in FIG. 1) formed therein. As a result, the refrigerant m1 flows into the first heat exchange core 11A and the second heat exchange core 11B. Note that in the present embodiment, as an example, the configuration and size of the second heat exchange core 11B are similar to those of the first heat exchange core 11A, but the present invention is not limited thereto, and the first heat exchange core 11A and the second heat exchange core 11B may be heat exchange cores having different configurations and/or sizes.

The state and temperature of the refrigerant m1 change during circulation in the refrigerant circuit R, but the high-temperature refrigerant m1 flows inside the first heat exchange core 11A. Hereinafter, the high-temperature refrigerant m1 circulating through the first heat exchange core 11A is referred to as high-temperature refrigerant mh1. The inlet 34A and outlet 35A of the first heat exchange core 11A are hereinafter referred to as a high-temperature refrigerant inlet 34A and a high-temperature refrigerant outlet 35A.

On the other hand, the low-temperature refrigerant m1 flows inside the second heat exchange core 11B. Hereinafter, the low-temperature refrigerant m1 circulating through the second heat exchange core 11B is referred to as low-temperature refrigerant mc1. The inlet 34B and outlet 35B of the second heat exchange core 11B are hereinafter referred to as a low-temperature refrigerant inlet 34B and a low-temperature refrigerant outlet 35B.

The case 3 has a substantially hexahedral (for example, substantially rectangular parallelepiped or substantially cubic) shape as a whole, and has a hollow internal space. Specifically, the case 3 has a body portion 33 having a substantially rectangular tubular shape with both ends in the lamination direction z opened, and an upper cover member and a lower cover member (both not illustrated in FIG. 1) that cover the openings of the body portion 33. The case 3 is made of, for example, a resin material.

As illustrated in FIGS. 2 and 3, the internal space of the case 3 is a chamber 30 in which the heat exchange core 11 can be accommodated. Specifically, the case 3 has a plurality of chambers 30 (here, first chamber 30A and second chamber 30B). The internal space of the case 3 also has a substantially hexahedral shape (for example, substantially rectangular parallelepiped shape) along the outer shape, but is provided with a partition portion 30P dividing the internal space into two. The partition portion 30P is also made of, for example, a resin material, and the internal space is divided into the first chamber 30A and the second chamber 30B by the partition portion 30P. Both the first chamber 30A and the second chamber 30B have shapes and sizes capable of accommodating the heat exchange cores 11. The first heat exchange core 11A is accommodated in the first chamber 30A to form the first heat exchanger 10A. Moreover, the second heat exchange core 11B is accommodated in the second chamber 30B to form the second heat exchanger 10B. A predetermined gap G1 is secured between the inner wall of the first chamber 30A and the outer surface (in this example, four surfaces facing the inner wall of the first chamber 30A) of the first heat exchange core 11A, and a predetermined gap G2 is also secured between the inner wall of the second chamber 30B and the outer surface (in this example, four surfaces facing the inner wall of the second chamber 30B) of the second heat exchange core 11B. Further, the inner wall of the first chamber 30A and the outer surface of the first heat exchange core 11A may be in close contact with each other, that is, the size of the gap G1 may be substantially 0 (zero). Similarly, the inner wall of the second chamber 30B and the outer surface of the second heat exchange core 11B may be in close contact with each other, that is, the size of the gap G2 may be substantially 0 (zero).

As an example, the case 3, the first chamber 30A, and the second chamber 30B each have rectangular shapes (oblong shapes) in which a length in the circulation direction x is longer than a length in the width direction y in the plan view from the lamination direction z as illustrated in FIG. 2. That is, in plan view, the first chamber 30A has short sides SS1 and long sides LS1, and the second chamber 30B also has short sides SS2 and long sides LS2. Both the chambers 30A, 30B are arranged adjacent to each other such that the long sides LS1, LS2 are along the circulation direction x. Further, one of the opposing short sides SS1 of the first chamber 30A is formed by the partition portion 30P, and is shared with one of the opposing short sides SS2 of the second chamber 30B. That is, the first chamber 30A and the second chamber 30B are adjacent to each other through the partition portion 30P.

The body portion 33 of the case 3 has a first side surface 33A and a second side surface 33B facing each other, and a third side surface 33C and a fourth side surface 33D facing each other. One of the long sides LS1, LS2 forms the first side surface 33A, and the other one of the long sides LS1, LS2 forms the second side surface 33B. In addition, one of the short sides (here, short side SS1) forms the fourth side surface 33D, and the other short side (here, short side SS2) forms the third side surface 33C.

Each of the plurality of chambers 30 includes an inlet 36 (36A, 36B) and an outlet 37 (37A, 37B) for the heat medium m2, and the heat medium m2 flows inside the case 3 (first chamber 30A, second chamber 30B). In this example, the second side surface 33B (long side LS1 of the first chamber 30A) is provided with the inlet 36A communicating with the first chamber 30A, and similarly, the second side surface 33B (long side LS2 of the second chamber 30B) is provided with the inlet 36B communicating with the second chamber 30B. Moreover, the fourth side surface 33D (short side SS1 of the first chamber 30A) is provided with the outlet 37A communicating with the first chamber 30A, and similarly, the third side surface 33C (short side SS2 of the second chamber 30B) is provided with the outlet 37B communicating with the second chamber 30B.

In this example, the first heat exchange core 11A is accommodated in the first chamber 30A, and the high-temperature first heat medium m1 (high-temperature refrigerant mh1) flows therein. Then, the second heat medium m2 circulating in the high-temperature side heat medium circuit 5 and exchanging heat with the high-temperature refrigerant mh1 flows in the first chamber 30A. The temperature of the second heat medium m2 changes during circulation in the high-temperature side heat medium circuit 5, but the second heat medium m2 is on the high-temperature side in the vehicle air conditioning device 100 when flowing through the first chamber 30A. In the present embodiment, particularly in the description of the heat exchanger 10, the second heat medium m2 flowing through the first chamber 30A is referred to as a high-temperature side heat medium mh2 for the sake of convenience of description. The first chamber 30A is a high-temperature side chamber through which the high-temperature side heat medium mh2 flows. Hereinafter, the inlet 36A of the first chamber 30A is referred to as a high-temperature side heat medium inlet 36A, and the outlet 37A of the first chamber 30A is referred to as a high-temperature side heat medium outlet 37A.

The second heat exchange core 11B is accommodated in the second chamber 30B. The low-temperature first heat medium m1 (low-temperature refrigerant mc1) flows inside the second heat exchange core 11B. Then, the second heat medium m2 circulating in the low-temperature side heat medium circuit 6 and exchanging heat with the low-temperature refrigerant mc1 flows in the second chamber 30B. In this case, the second heat medium m2 flowing through the second chamber 30B is the low-temperature side second heat medium m2 in the vehicle air conditioning device 100, and in the present embodiment, particularly in the description of the heat exchanger 10, is referred to as a low-temperature side heat medium mc2. The second chamber 30B is a low-temperature side chamber through which the low-temperature side heat medium mc2 flows. Hereinafter, the inlet 36B of the second chamber 30B is referred to as a low-temperature side heat medium inlet 36B, and the outlet 37B of the second chamber 30B is referred to as a low-temperature side heat medium outlet 37B.

The second heat medium m2 (high-temperature side heat medium mh2) flowing into the first chamber 30A through the high-temperature side heat medium inlet 36A flows toward the high-temperature side heat medium outlet 37A using the gap G1 between the inner wall of the first chamber 30A and the first heat exchange core 11A and a gap (described later) formed by the first heat exchange core 11A as a channel, and exchanges heat with the first heat medium m1 (high-temperature refrigerant mh1) flowing inside the first heat exchange core 11A.

Similarly, the second heat medium m2 (low-temperature side heat medium mc2) flowing into the second chamber 30B through the low-temperature side heat medium inlet 36B flows toward the low-temperature side heat medium outlet 37B using the gap G2 between the inner wall of the second chamber 30B and the second heat exchange core 11B and a gap (described later) formed by the second heat exchange core 11B as a channel, and exchanges heat with the first heat medium m1 (low-temperature refrigerant mc1) flowing inside the second heat exchange core 11B.

In the heat exchanger 10 of the present embodiment, since the two heat exchange cores 11 (11A, 11B) are accommodated in one case 3 (the case 3 can be made common), the number of components can be reduced as compared with a configuration in which the heat exchange cores 11 are individually (independently) accommodated in cases, and accordingly, cost reduction and space saving can be achieved.

In addition, since the first chamber 30A and the second chamber 30B are reliably divided by the partition portion 30P and respectively accommodate the first heat exchange core 11A and the second heat exchange core 11B, the first heat exchange core 11A and the second heat exchange core 11B can be set as different temperature control targets. That is, the second heat medium m2 of which the temperature has been controlled to a desired temperature range can be supplied to different temperature control targets (first heat exchange core 11A, second heat exchange core 11B).

Specifically, for example, the first heat exchange core 11A is a high-temperature side heat exchange core 11A through which the high-temperature refrigerant mh1 flows in the vehicle air conditioning device 100 (refrigerant circuit R), and the second heat exchange core 11B is a low-temperature side heat exchange core 11B through which the low-temperature refrigerant mc1 flows in the vehicle air conditioning device 100 (refrigerant circuit R).

Here, the first chamber 30A and the second chamber 30B are reliably partitioned by the partition portion 30P, and the high-temperature side heat medium mh2 circulating through the first chamber 30A and the low-temperature side heat medium mc2 circulating through the second chamber 30B are not mixed. On the other hand, one surface of the partition portion 30P is in contact with the high-temperature side heat medium mh2 and the other surface is in contact with the low-temperature side heat medium mc2, and there is a temperature difference between both surfaces of one (common) partition portion 30P. If the temperature difference is too great, thermal distortion may occur particularly in a case where the partition portion 30P and the case 3 are made of resin.

In the present embodiment, by devising the channel for the heat medium m2 (high-temperature side heat medium mh2 and low-temperature side heat medium mc2), the thermal distortion occurring in the case 3 due to the temperature difference of the heat medium m2 is reduced. This will be described below.

Referring to FIG. 3, the channel (high-temperature channel F1) for the high-temperature side heat medium mh2 in the first chamber 30A flows from the high-temperature side heat medium inlet 36A toward the high-temperature side heat medium outlet 37A. The high-temperature side heat medium mh2 passes through the heat medium channel WA (described later) defined by the first heat exchange core 11A, and actually flows through a complicated path, but in the following description, such a path is described macroscopically and schematically as a path from the high-temperature side heat medium inlet 36A toward the high-temperature side heat medium outlet 37A. That is, the high-temperature channel F1 extends from the high-temperature side heat medium inlet 36A toward the high-temperature side heat medium outlet 37A, and is formed in a substantially L shape as a whole.

Similarly, when described macroscopically and schematically, the channel (low-temperature channel F2) for the low-temperature side heat medium mc2 in the second chamber 30B is formed in a substantially L shape as a whole from the low-temperature side heat medium inlet 36B toward the low-temperature side heat medium outlet 37B.

In this example, the downstream side (region in the vicinity of the high-temperature side heat medium outlet 37A, which is located downstream of the center of the high-temperature channel F1 and particularly includes a downstream end portion, downstream region Fd1) of the high-temperature channel F1 is farther from the partition portion 30P than the upstream side (region in the vicinity of the high-temperature side heat medium inlet 36A, which is located upstream of the center of the high-temperature channel F1 and particularly includes an upstream end portion, upstream region Fu1) of the high-temperature channel F1.

Specifically, in this example, the high-temperature side heat medium inlet 36A and the high-temperature side heat medium outlet 37A are provided such that the upstream region Fu1 of the high-temperature channel F1 is close to the partition portion 30P and the downstream region Fd1 of the high-temperature channel F1 is farther from the partition portion 30P.

The high-temperature side heat medium inlet 36A is provided in the vicinity of the partition portion 30P on the long side LS1 (second side surface 33B), and the high-temperature side heat medium outlet 37A is provided close to the first side surface 33A on the short side SS1 (fourth side surface 33D) facing the partition portion 30P. As a result, the high-temperature channel F1 flows in the width direction y (direction toward the first side surface 33A) along the partition portion 30P in the upstream region Fu1, the channel is gradually bent in the circulation direction x toward the fourth side surface 33D, and flows along the first side surface 33A in the downstream region Fd1.

The low-temperature channel F2 is provided so as to be line-symmetric with the high-temperature channel F1 with respect to the partition portion 30P. That is, the downstream side (region in the vicinity of the low-temperature side heat medium outlet 37B, which is located downstream of the low-temperature channel F2 and includes a downstream end portion, downstream region Fd2) of the low-temperature channel F2 is farther from the partition portion 30P than the upstream side (region in the vicinity of the low-temperature side heat medium inlet 36B, which is located upstream of the low-temperature channel F2 and includes an upstream end portion, upstream region Fu2) of the low-temperature channel F2.

Specifically, in this example, the low-temperature side heat medium inlet 36B and the low-temperature side heat medium outlet 37B are provided such that the upstream region Fu2 of the low-temperature channel F2 is close to the partition portion 30P and the downstream region Fd2 of the low-temperature channel F2 is farther from the partition portion 30P.

The low-temperature side heat medium inlet 36B is provided in the vicinity of the partition portion 30P on the long side LS2 (second side surface 33B), and the low-temperature side heat medium outlet 37B is provided close to the first side surface 33A on the short side SS2 (third side surface 33C) facing the partition portion 30P. As a result, the low-temperature channel F2 flows in the width direction y (direction toward the first side surface 33A) along the partition portion 30P in the upstream region Fu2, the channel is gradually bent in the circulation direction x toward the third side surface 33C, and flows along the first side surface 33A in the downstream region Fd2.

The high-temperature side heat medium mh2 flowing through the first chamber 30A has the highest temperature in the vicinity of the high-temperature side heat medium outlet 37A subjected to heat exchange by the first heat exchange core 11A, and the temperature thereof is lower in the vicinity of the high-temperature side heat medium inlet 36A than in the vicinity of the high-temperature side heat medium outlet 37A. The low-temperature side heat medium mc2 flowing through the second chamber 30B has the highest temperature in the vicinity of the low-temperature side heat medium outlet 37B subjected to heat exchange by the second heat exchange core 11B, and the temperature thereof is higher in the vicinity of the low-temperature side heat medium inlet 36B than in the vicinity of the low-temperature side heat medium outlet 37B. That is, in the vicinity of the high-temperature side heat medium outlet 37A and the low-temperature side heat medium outlet 37B (downstream region Fd1 of the high-temperature channel F1 and downstream region Fd2 of the low-temperature channel F2), the temperature difference between the high-temperature side heat medium mh2 and the low-temperature side heat medium mc2 is greater than that in the vicinity of the high-temperature side heat medium inlet 36A and the low-temperature side heat medium inlet 36B (upstream region Fu1 of the high-temperature channel F1 and upstream region Fu2 of the low-temperature channel F2), and is the maximum in the refrigerant circuit R.

Thus, in the present embodiment, both the high-temperature side heat medium outlet 37A and the low-temperature side heat medium outlet 37B are provided at positions far from the partition portion 30P (as much as possible), and the downstream region Fd1 of the high-temperature channel F1 and the downstream region Fd2 of the low-temperature channel F2 are configured far from the partition portion 30P.

In a case where the heat medium m2 flows with a great temperature difference on both sides of one (common) partition portion 30P (in contact therewith), there is a problem that the thermal distortion occurs in the resin partition portion 30P and the case 3 therearound and the case 3 is damaged. In the present embodiment, since it is possible to minimize a region (opportunity) where the heat media m2 having a great temperature difference are in contact with each other through the partition portion 30P and other portions of the case 3, it is possible to reduce the thermal distortion of the case 3 due to the temperature difference of the heat medium m2.

Both the high-temperature side heat medium inlet 36A and the low-temperature side heat medium inlet 36B are provided at positions close to the partition portion 30P (as much as possible). As a result, the upstream region Fu1 of the high-temperature channel F1 and the upstream region Fu2 of the low-temperature channel F2 (regions where the temperature difference between the high-temperature side heat medium mh2 and the low-temperature side heat medium mc2 is small) flow on the both sides along the partition portion 30P (in contact therewith), and as the temperature difference therebetween increases, flow toward the high-temperature side heat medium outlet 37A and the low-temperature side heat medium outlet 37B on the paths apart from the partition portion 30P. That is, since the upstream region Fu1 of the high-temperature channel F1 and the upstream region Fu2 of the low-temperature channel F2 having a relatively-small temperature difference can flow substantially exclusively along the vicinity of the partition portion 30P, it is possible to reduce a room for the heat media m2 with a great temperature difference flowing in the vicinity of the partition portion 30P.

As illustrated in FIG. 2, the refrigerant m1 flowing in each of the heat exchange cores 11A, 11B circulates so as to face the heat medium m2. Thus, even when focusing on the temperature difference between the high-temperature refrigerant mh1 and the low-temperature refrigerant mc1, the high-temperature refrigerant mh1 and the low-temperature refrigerant mc1 after having substantially exchanged heat, that is, having a small temperature difference, flow in the vicinity of the partition portion 30P, whereby the thermal distortion of the case 3 can also be reduced.

As a result, the high-temperature side heat medium inlet 36A and the low-temperature side heat medium inlet 36B come close to each other, and the high-temperature side heat medium outlet 37A and the low-temperature side heat medium outlet 37B are separated from each other (to the maximum extent). That is, a distance (inter-outlet distance) L2 between the high-temperature side heat medium outlet 37A and the low-temperature side heat medium outlet 37B is longer than a distance (inter-inlet distance) L1 between the high-temperature side heat medium inlet 36A and the low-temperature side heat medium inlet 36B. That is, since the inter-outlet distance L2 is longer than the inter-inlet distance L1, it is possible to minimize the region (opportunity) where the heat media m2 having a great temperature difference are in contact with each other through the partition portion 30P and other portions of the case 3, and it is possible to reduce the thermal distortion of the case 3 due to the temperature difference of the heat medium m2.

Further, as illustrated in FIG. 2, the first chamber 30A and the second chamber 30B are preferably disposed side by side such that the long sides LS1, LS2 thereof are aligned with each other (the extending directions thereof coincide with each other). In this case, in the first chamber 30A, the high-temperature side heat medium outlet 37A is provided on the short side SS1 (or the position farthest from the partition portion 30P on the long side LS1) facing the partition portion 30P, and in the second chamber 30B, the low-temperature side heat medium outlet 37B is provided on the short side SS2 (or the position farthest from the partition portion 30P on the long side LS2) facing the partition portion 30P. As a result, the inter-outlet distance L2 can be increased as compared with a case where the chambers 30A, 30B are disposed side by side such that the short sides SS1, SS2 are aligned with each other. That is, the downstream region Fd1 of the high-temperature channel F1 and the downstream region Fd2 of the low-temperature channel F2 can be separated from each other to the maximum extent, which is more preferable from the viewpoint of reducing the thermal distortion of the case 3.

Here, regarding the distance between the inlet 36 (outlet 37) and the partition portion 30P, a “distance from the inlet 36 (outlet 37) to the partition portion 30P” refers to, for example, a “perpendicular distance from the openings OP of the inlet 36 and the outlet 37 to the plane of the partition portion 30P in the plan view from the lamination direction z”. The openings OP of the inlet 36 and the outlet 37 are formed, for example, in a substantially circular shape in the inner surface of the chamber 30, and are provided in parallel to (facing) the plane of the partition portion 30P or perpendicular to the plane of the partition portion 30P depending on the positions of the inlet 36 and the outlet 37. In a case where the opening OP is provided perpendicularly to the plane of the partition portion 30P (in the case of the inlet 36 in FIG. 3), the distance is a perpendicular distance (see a distance d1 in FIG. 3) between the center axis C1 of the opening OP and the center (plane passing therethrough) C0 of the partition portion 30P in the thickness direction thereof. In a case where the opening OP is provided in parallel to (facing) the plane of the partition portion 30P (in the case of the outlet 37 in FIG. 3), the distance is a perpendicular distance (see a distance d2 in FIG. 3) between the opening OP (the plane thereof) and the center (plane passing therethrough) of the partition portion 30P in the thickness direction thereof.

The inter-inlet distance L1 (inter-outlet distance L2) is, for example, a “perpendicular distance between the openings OP in the plan view from the lamination direction z across the partition portion 30P”. In a case where the openings OP are provided perpendicular to the plane of the partition portion 30P (in the case of the inlet 36 in FIG. 3), the distance is a perpendicular distance (see a distance d3 in FIG. 3) between the central axes C1 of the openings OP across the partition portion 30P. In a case where the openings OP are provided in parallel to (facing) the plane of the partition portion 30P (in the case of the outlet 37 in FIG. 3), the distance is a perpendicular distance (see a distance d4 in FIG. 3) between the openings OP (the planes thereof) across the partition portion 30P.

In the example above, the first heat exchange core 11A (first chamber 30A) side is the high-temperature side, and the second heat exchange core 11B (second chamber 30B) side is the low-temperature side. However, the same applies to a case when these sides are switched (the same applies to the following description).

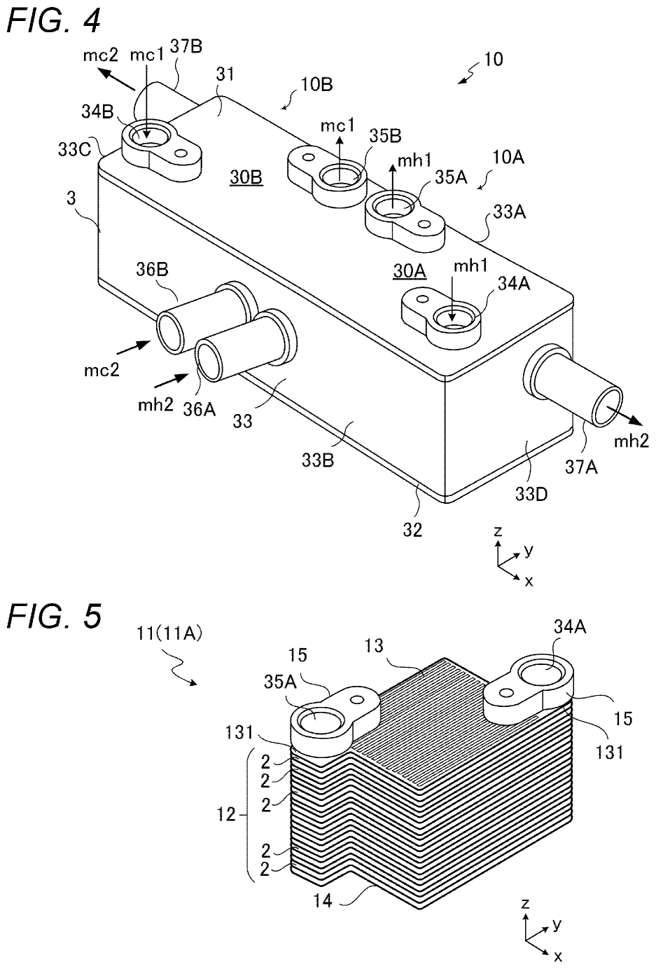

Hereinafter, with reference to FIGS. 4 and 5, the heat exchanger 10 of the present embodiment will be described in more detail with reference to a specific example. Each configuration of the heat exchanger 10 illustrated in FIGS. 4 and 5 is an example, and the heat exchanger 10 is not limited to the configurations illustrated in FIGS. 4 and 5.

### <Heat Exchanger>

FIG. 4 is an external perspective view of the heat exchanger 10, and FIG. 5 is a perspective view of the heat exchange core 11. Referring to FIG. 4, the heat exchanger 10 has the case 3 having a substantially hexahedral outer shape, and the heat exchange core 11 is accommodated therein. The case 3 has the rectangular tubular body portion 33 opened at both ends in the lamination direction z, and an upper cover member 31 and a lower cover member 32 covering the openings. On the first chamber 30A side, the high-temperature refrigerant inlet 34A through which the high-temperature refrigerant mh1 flows in and the high-temperature refrigerant outlet 35A through which the high-temperature refrigerant mh1 flows out are provided at diagonal positions at the upper cover member 31. At the sides of the first chamber 30A, the high-temperature side heat medium inlet 36A through which the high-temperature side heat medium mh2 flows in is provided on the second side surface 33B of the case 3, and the high-temperature side heat medium outlet 37A through which the high-temperature side heat medium mh2 flows out is provided on the fourth side surface 33D.

On the second chamber 30B side, the low-temperature refrigerant inlet 34B through which the low-temperature refrigerant mc1 flows in and the low-temperature refrigerant outlet 35B through which the low-temperature refrigerant mc1 flows out are provided at diagonal positions at the upper cover member 31. At the sides of the second chamber 30B, the low-temperature side heat medium inlet 36B through which the low-temperature side heat medium mc2 flows in is provided on the second side surface 33B of the case 3, and the low-temperature side heat medium outlet 37B through which the low-temperature side heat medium mc2 flows out is provided on the third side surface 33C.

FIG. 5 is a perspective view of one heat exchange core 11 (for example, first heat exchange core 11A). Since the first heat exchange core 11A (first chamber 30A) and the second heat exchange core 11B (second chamber 30B) have similar configurations except that the heat medium flowing therein is different, the first heat exchange core 11A and the second heat exchange core 11B, that is, the high-temperature side and the low-temperature side, will be described with reference to FIG. 5 without being distinguished from each other.

### <Heat Exchange Core>

The heat exchange core 11 (for example, first heat exchange core 11A) is provided with two pads 15 at diagonal positions in the plan view from the lamination direction z. Each pad 15 has a through-hole, a refrigerant inlet 34 (for example, high-temperature refrigerant inlet 34A) of the heat exchange core 11 is formed by the through-hole of one pad 15, and a refrigerant outlet 35 (for example, high-temperature refrigerant outlet 35A) is formed by the through-hole of the other pad 15. The heat exchange core 11 is accommodated in the case 3 except for the two pads 15. A main portion of the heat exchanger core 11 is accommodated in the case 3 and covered with the upper cover member 31 and the lower cover member 32 (see FIG. 4).

The heat exchange core 11 has a core portion 12 in which a plurality of heat exchange plates 2 is laminated on each other in the lamination direction z, an upper end plate 13 provided above the core portion 12 in the lamination direction z, and a lower end plate 14 provided below the core portion 12 in the lamination direction z. The heat exchange plate 2, the upper end plate 13, the lower end plate 14, and the pad 15 are made of aluminum, and the heat exchange core 11 is formed by integrating these aluminum components by brazing for aluminum or the like. The outer surface of the heat exchange core 11 may be coated with resin to prevent deterioration of the aluminum heat exchange core 11 due to the second heat medium m2. Inside one heat exchange plate 2, a channel (refrigerant channel CA, CB illustrated in FIG. 1) for the refrigerant m1 flowing from the refrigerant inlet 34 toward the refrigerant outlet 35 is formed. In addition, a gap is secured between the laminated (upper and lower) heat exchange plates 2 (channel bulging portions 131, 131), and this gap serves as a channel (heat medium channel WA, WB illustrated in FIG. 1) for the second heat medium m2.

The heat medium m2 having flowed into the chamber 30 through the heat medium inlet 36 (for example, high-temperature side heat medium inlet 36A) is divided in the lamination direction z and the width direction y, passes between the plurality of heat exchange plates 2 and the gap G1 between the side surface of the core portion 12 and the case 3, and flows out through the heat medium outlet 37 (for example, high-temperature side heat medium outlet 37A). As a result, the heat medium m2 macroscopically and schematically flows through the high-temperature channel F1 (the same applies to the low-temperature channel F2) as illustrated in FIG. 3. Then, in each of the heat exchange cores 11, the first heat medium m1 and the second heat medium m2 circulate in directions facing each other. In this manner, heat is exchanged between the first heat medium m1 inside the heat exchange plate 2 and the second heat medium m2 outside the heat exchange plate 2.

### <Modification>

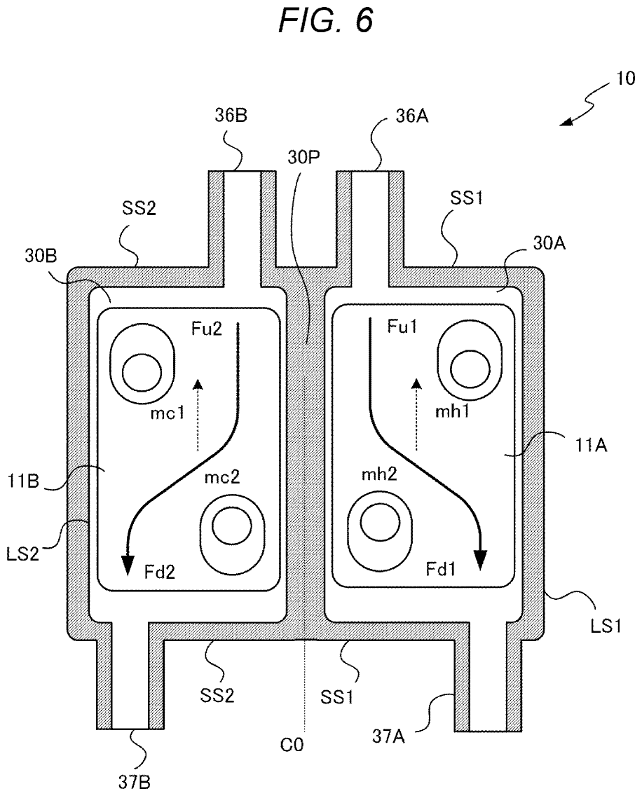

A modification of the present embodiment will be described with reference to FIG. 6. It may be possible for the heat exchanger 10 to minimize the region (opportunity) where the heat media m2 having a great temperature difference are in contact with each other through the partition portion 30P and other portions of the case 3. In FIG. 6, the high-temperature channel F1 and the low-temperature channel F2 are indicated by large arrows macroscopically and schematically. The tip end side of the large arrow indicates the downstream regions Fd1, Fd2, and the base end side indicates the upstream regions Fu1, Fu2.

In the example of FIG. 6, the orientations of the chambers 30A, 30B and the heat exchange cores 11A, 11B (the circulation direction x of the first heat medium m1) are rotated by 90 degrees from those in the configuration of FIG. 2, and the short sides SS1, SS2 are disposed so as to be aligned with each other. In this case, the long sides LS1, LS2 face the partition portion 30P, and both the inlet 36 and the outlet 37 are provided on the short sides SS1, SS2.

Further, in the configuration illustrated in FIG. 6, the outlet 37 may be provided on the long side LS1, LS2.

In addition, in the configuration illustrated in FIG. 2, the first chamber 30A and the second chamber 30B may be provided such that the inflow directions thereof through the inlets 36A, 36B face each other. Specifically, for example, the high-temperature side heat medium inlet 36A may be provided in the first side surface 33A, and the low-temperature side heat medium inlet 36B may be provided in the second side surface 33B. In addition, the positions of the outlets 37A, 37B provided on the short sides SS1, SS2 may be positions shifted from each other in the width direction y (for example, one is a position close to the second side surface 33B, and the other is a position close to the first side surface 33A).

Further, in the configuration illustrated in FIG. 2, the two inlets 36 may be provided at positions not in the immediate vicinity of the partition portion 30P (for example, the vicinity of substantially the center of the long sides LS1, LS2, or the like.). As long as the downstream region Fd1 of the high-temperature channel F1 and the downstream region Fd2 of the low-temperature channel F2, where the temperature difference between the high-temperature side heat medium mh2 and the low-temperature side heat medium mc2 is the maximum, are separated from the partition portion 30P (separated from the upstream regions Fu1, Fu2), the two inlets 36 are not necessarily provided in the immediate vicinity of the partition portion 30P.

For example, in the configuration illustrated in FIG. 2, the high-temperature side-heat medium outlet 37A may be provided close to the fourth side surface 33D in the first side surface 33A, or the low-temperature side heat medium outlet 37B may be provided close to the third side surface 33C in the first side surface 33A.

In both the configuration illustrated in FIG. 6 and the configuration above, the distance from the outlets 37A, 37B to the partition portion 30P is greater than the distance from the inlets 36A, 36B to the partition portion 30P. Alternatively, the inter-outlet distance L2 is greater than the inter-inlet distance L1.

With this configuration, the downstream region Fd1 of the high-temperature channel F1 and the downstream region Fd2 of the low-temperature channel F2, where the temperature difference between the high-temperature side heat medium mh2 and the low-temperature side heat medium mc2 is the maximum, can be separated from the partition portion 30P (separated more greatly than the distance between the upstream regions Fu1, Fu2 and the partition portion 30P).

Also in the configuration illustrated in FIG. 6, the upstream region Fu1 of the high-temperature channel F1 and the upstream region Fu2 of the low-temperature channel F2, where the temperature difference between the high-temperature side heat medium mh2 and the low-temperature side heat medium mc2 is small, can be along the partition portion 30P. Thus, the thermal distortion of the case 3 due to the temperature difference of the heat medium m2 can be reduced.

Note that although not illustrated, a heat insulating member may be accommodated in the partition portion 30P, or the partition portion 30P may be formed of a heat insulating member.

The refrigerant channels (the same applies to the heat medium channels) provided in the plurality of heat exchange cores 11 may have similar shapes among all the heat exchange cores 11, or the refrigerant channel(s) of one or some of the heat exchange cores 11 may have shapes different from those of the other heat exchange cores 11.

In addition, the number of chambers 30 and the number of heat exchange cores 11 may be three or more as long as the downstream side channel Fd for the second heat medium m2 flowing inside the adjacent chambers 30 is provided at a position farther from the partition portion 30P than the upstream side channel Fu.

The present invention is not limited to the foregoing embodiments, and various modifications can be made without deviating from the gist of the present invention.

LIST OF REFERENCE SIGNS

| | |
|---|---|
| 1 | Compressor |
| 3 | Case |
| 5 | High-temperature side heat medium circuit |
| 6 | Low-temperature side heat medium circuit |
| 10 | Heat exchanger |
| 11, 11A, 11B | Heat exchange core |
| 15 | Pad |
| 30 | Chamber |
| 30P | Partition portion |
| 33 | Body portion |
| 34 | Refrigerant inlet |
| 34A | High-temperature refrigerant inlet |
| 34B | Low-temperature refrigerant inlet |
| 35 | Refrigerant outlet |
| 35A | High-temperature refrigerant outlet |
| 35B | Low-temperature refrigerant outlet |
| 36 | Inlet |
| 36A | High-temperature side heat medium inlet |
| 36B | Low-temperature side heat medium inlet |
| 37 | Outlet |
| 37A | High-temperature side heat medium outlet |
| 37B | Low-temperature side heat medium outlet |
| 70 | Pipe (refrigerant pipe) |
| 71 | Pipe (heat medium pipe) |
| F1 | High-temperature channel |
| F2 | Low-temperature channel |
| Fu | Upstream side channel |
| Fd | Downstream side channel |
| Fu1, Fu2 | Upstream region |
| Fd1, Fd2 | Downstream region |
| R | Refrigerant circuit |
| m1 | Refrigerant (first heat medium) |
| m2 | Heat medium (second heat medium) |
| mc1 | Low-temperature refrigerant |
| mc2 | Low-temperature side heat medium |
| mh1 | High-temperature refrigerant |
| mh2 | High-temperature side heat medium |

1. A heat exchanger comprising:
a plurality of heat exchange cores through which a first heat medium flows; and
a case of which an inside is divided into a plurality of chambers by a partition portion,
wherein the heat exchange cores are each accommodated in the chambers adjacent to each other through the partition portion,
each of the chambers is configured such that a second heat medium flows therethrough and heat is exchanged between the second heat medium and the first heat medium,
each of the chambers has an inlet and an outlet for the second heat medium, and is configured to cause the second heat medium to circulate in the each of the chambers to exchange heat between the second heat medium and the first heat medium, and
a channel for the second heat medium on a downstream side in each of the chambers is provided at a position farther from the partition portion than a channel for the second heat medium on an upstream side.

2. The heat exchanger according to claim 1, wherein
the channel for the second heat medium on the upstream side in each of the chambers adjacent to each other is provided at a position close to the partition portion.

3. The heat exchanger according to claim 1, wherein
in the chambers adjacent to each other, each of the inlets is provided at a position close to the partition portion, and each of the outlets is provided at a position far from the partition portion.

4. The heat exchanger according to claim 1, wherein
in the chambers adjacent to each other, a distance between the outlets is greater than a distance between the inlets.

5. The heat exchanger according to claim 1, wherein
a temperature difference in the second heat medium flowing through each of the chambers adjacent to each other on the downstream side is greater than a temperature difference on the upstream side.

6. The heat exchanger according to claim 1, wherein
the heat exchange core functioning as a heater is accommodated in one of the chambers adjacent to each other, and the heat exchange core functioning as a cooler is accommodated in the other chamber.

7. A vehicle air conditioning device comprising: the heat exchanger according to claim 1.

8. A vehicle air conditioning device comprising: the heat exchanger according to claim 2.

9. A vehicle air conditioning device comprising: the heat exchanger according to claim 3.

10. A vehicle air conditioning device comprising: the heat exchanger according to claim 4.

11. A vehicle air conditioning device comprising: the heat exchanger according to claim 5.

12. A vehicle air conditioning device comprising: the heat exchanger according to claim 6.
